(19) United States
(12) Patent Application Publication
(10) Pub. No.: US 2026/0299828 A1
(43) Pub. Date: Oct. 1, 2026

(54) METHOD FOR DYNAMIC CACHE CONTROL, AND ASSOCIATED APPARATUS

(71) Applicant: MEDIATEK INC., Hsinchu City (TW)

(72) Inventors: Po-Yu Huang, Hsinchu City (TW); Chih-Chun Chiu, Hsinchu City (TW); Kai-Hsiang Chang, Hsinchu City (TW); Chin-fa Su, Hsinchu City (TW); Shih-Chin Lin, Hsinchu City (TW); Wei-Chun Tai, Hsinchu City (TW); Ching Pan, Hsinchu City (TW); Ling-Chien Yang, Hsinchu city (TW); Meng-Chih Chang, Hsinchu City (TW); Tung-Hsuan Lin, Hsinchu City (TW); Ta-Kai Lin, Hsinchu City (TW); Chia-Hsiu Chuang, Hsinchu City (TW); Cheng-Hung Wu, Hsinchu City (TW); Chi-An Chen, Hsinchu City (TW)

(73) Assignee: MEDIATEK INC., Hsinchu City (TW)

(21) Appl. No.: 19/634,029

(22) Filed: Mar. 30, 2026

Related U.S. Application Data
(60) Provisional application No. 63/781,441, filed on Apr. 1, 2025.

(51) Int. Cl. G06F 3/06

(52) U.S. Cl. CPC G06F 3/0656; G06F 3/0611; G06F 3/0673

(57) ABSTRACT

A method for dynamic cache control and an associated apparatus are provided. The method may include: building, by a processing unit, a first command for a first processing stage, wherein the first command is configured to assign a buffer identifier (ID) to a dedicated-allocated type of target data; setting, by a cache unit, a state of the buffer ID to a dedicated-allocate state to allow the target data to be stored in a cache space corresponding to the buffer ID; building, by the processing unit, a second command for a second processing stage, wherein the second command is configured to change the state of the buffer ID to a released state; and setting, by the cache unit, the state of the buffer ID to the released state to allow the target data stored in the cache space corresponding to the buffer ID to be replaced.

### CROSS REFERENCE TO RELATED APPLICATIONS

This application claims the benefit of U.S. Provisional Application No. 63/781,441, filed on April 1, 2025. The content of the application is incorporated herein by reference.

### BACKGROUND

The present disclosure relates to cache management, and in particular, to a method for dynamic cache control, and to an associated apparatus.

Nowadays, mobile application (app) stores typically offer a wide variety of games that require a large amount of mobile system resources, making it increasingly challenging to deliver a smooth and satisfying user experience. High-resolution and large-sized high-quality texture games significantly increase the demand for memory access bandwidth. When this demand exceeds what mobile platforms can provide, it becomes a system bottleneck and may lead to unstable frame rates. According to the related art, computer processors are typically equipped with multiple types and layers of cache hardware to reduce memory bandwidth usage and improve data-access efficiency. However, these caches are typically designed as general-purpose resources and are shared across various units throughout the system, and the caching mechanism is not optimized for graphics rendering. As a result, data frequently competes for cache space, causing repeated cache-flush and write-back operations. In particular, data may be frequently written back to memory and then reloaded or reallocated back into the cache, resulting in additional memory bandwidth overhead. Therefore, a novel method and associated architecture are needed for solving the problems without introducing any side effect or in a way that is less likely to introduce a side effect.

### SUMMARY

It is an objective of the present disclosure to provide a method for dynamic cache control, and to provide an associated apparatus, in order to solve the problems in the related art.

At least one embodiment of the present disclosure provides a method for dynamic cache control, where the method may comprise: building, by a processing unit, a first command for a first processing stage, wherein the first command is configured to assign a buffer identifier (ID) to a dedicated-allocated type of target data; setting, by a cache unit, a state of the buffer ID to a dedicated-allocate state to allow the target data to be stored in a cache space corresponding to the buffer ID; building, by the processing unit, a second command for a second processing stage, wherein the second command is configured to change the state of the buffer ID to a released state; and setting, by the cache unit, the state of the buffer ID to the released state to allow the target data stored in the cache space corresponding to the buffer ID to be replaced.

At least one embodiment of the present disclosure provides an apparatus for dynamic cache control, wherein the apparatus comprises at least one processing circuit, and the processing circuit comprises a processing unit that is configured to perform at least one processing operation, and a cache unit that is configured to perform at least one caching operation. For example, the processing unit can be configured to build a first command for a first processing stage, wherein the first command is configured to assign a buffer ID to a dedicated-allocated type of target data. The cache unit can be configured to set a state of the buffer ID to a dedicated-allocate state to allow the target data to be stored in a cache space corresponding to the buffer ID. In addition, the processing unit can be configured to build a second command for a second processing stage, wherein the second command is configured to change the state of the buffer ID to a released state. Additionally, the cache unit can be configured to set the state of the buffer ID to the released state to allow the target data stored in the cache space corresponding to the buffer ID to be replaced.

It is an advantage of the present disclosure that, through proper design, the proposed method and the associated apparatus can provide a new type of cache-control mechanism that allows specific data to be dedicated in the cache during rendering and provides job-level fine-grained cache control. In particular, the proposed mechanism may be implemented using an existing cache unit with appropriate hardware support, or by incorporating an additional cache unit dedicated to this mechanism. In addition, the proposed method and the associated apparatus can solve the related art problems without introducing any side effect or in a way that is less likely to introduce a side effect.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for dynamic cache control according to an embodiment of the present disclosure, where the apparatus is configured to operate based on a method for dynamic cache control.

FIG. 2 illustrates a rendering control scheme of the method according to an embodiment of the present disclosure.

FIG. 3 illustrates some implementation details of the rendering control scheme shown in FIG. 2.

FIG. 4A illustrates respective operations of a graphics processing unit (GPU) and a GPU driver thereof in a cache quota management control scheme of the method according to an embodiment of the present disclosure.

FIG. 4B illustrates some operations of the cache unit shown in FIG. 1 with respect to a memory in the cache quota management control scheme shown in FIG. 4A.

FIG. 5 illustrates a basic case control scheme of the method according to an embodiment of the present disclosure.

FIG. 6 illustrates a multiple data control scheme of the method according to an embodiment of the present disclosure.

FIG. 7 illustrates a configuring timing control scheme of the method according to an embodiment of the present disclosure.

FIG. 8 illustrates a channel-wise control scheme of the method according to an embodiment of the present disclosure.

FIG. 9 illustrates a main working flow of the method according to an embodiment of the present disclosure.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The proposed method and the associated apparatus can enhance overall performance of an electronic device (e.g., a mobile device, controller) capable of running high-resolution and large-sized high-quality texture games. For better comprehension, in modern applications, a rendering flow may include multiple stages of processing, such as depth map generation, geometry buffer (G-buffer) construction, post-processing, user interface (UI) composition, and final display output for displaying on a screen. These stages of processing may be performed by a GPU using various types of jobs, including render-pass jobs, compute jobs, and transfer jobs. In more advanced applications, artificial intelligence (AI) computing jobs based on a deep learning neural network running on a neural processing unit (NPU), such as deep-learning inference operations, may also be involved in the pipeline. During rendering, certain data may exhibit a producer-consumer relationship, e.g., data produced in an earlier pass is consumed in a later pass. Based on this behavior, the proposed method can set or assign such data to be dedicated-allocated (in particular, in a dedicated-allocate state) in the cache when it is produced, and can release the dedicated allocation once the data is last consumed. During the interval between the time point at which the data is produced and the time point at which it is consumed, it may be accessed (e.g., read and/or written) multiple times with cache hits due to the dedicated-allocate state thereof in the cache. A higher cache hit rate (or a higher number of cache hits) can reduce the corresponding memory access operations and therefore lower the usage of the memory bandwidth. Furthermore, some data may be immediate data, meaning that it will never be used again once it has been consumed. For data with this kind of behavior, after the setting of the dedicated allocation is released, the data may be discarded and skipped from write-back to memory, allowing its cache quota to be reclaimed and replaced by other data such as subsequent or later data. In addition to the discard operation, the original flush operation is also supported. The proposed method and the associated apparatus can provide a new type of cache-control mechanism that allows designated data (e.g., selected data or targeted data) to be a dedicated-allocated state in the cache during operation (such as rendering or computing) and enables job-level fine-grained cache management. For ease of description and understanding, the embodiments of the present disclosure are described herein by taking image rendering via a GPU as an example. However, the present disclosure is not limited to this example. For instance, the techniques disclosed herein may be applied to any other suitable processing task. In the example of rendering images via GPU, the mechanism may comprise two major cache-control operations: (1) allocating frequently used GPU rendering data in the cache; and (2) releasing the cache quota of the target data when the target data runs out (or completes) its lifecycle. In the first operation among the two operations, frequently accessed GPU rendering data may be allocated in the cache (e.g., the device memory object of image type and/or buffer type) such that the cache quota (or size) occupied by the target data becomes dedicated, preventing other data from flushing it out of the cache. This behavior can increase the cache-hit rate for such frequently used data, thereby reducing the memory-bandwidth usage. The target data is not limited to a single object of image/buffer type. It may also be a group of objects, or even all access traffic of a certain channel type. For example, all texture-read access traffic of a render pass may be dedicated-allocated, or all depth-test access traffic of a render pass may be dedicated-allocated. In the second operation among the two operations, when the target data reaches the end of its lifecycle (i.e., last consumed), the dedicated cache quota of the target data can be released, allowing the target data to be replaced by other data (i.e., the target data will be discarded from the cache and skipped from write-back operations, which is different from conventional methods). By eliminating memory write-back for such data, memory-bandwidth usage can be further reduced. Additionally, this mechanism may be implemented using an existing cache unit with appropriate hardware support, or by adding new hardware dedicated to this mechanism. In such cases, the cache can be integrated as one of the layers in the system's memory hierarchy. The remaining unused cache quota may still be utilized by other GPU data and/or shared with other processing units (e.g., the NPU or a central processing unit (CPU)) in the system.

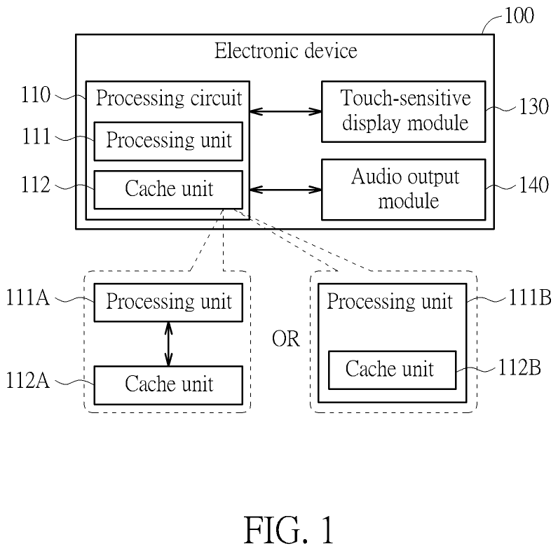

FIG. 1 is a diagram of an apparatus for dynamic cache control according to an embodiment of the present disclosure, where the apparatus is configured to operate based on a method for dynamic cache control. The apparatus can be implemented as an electronic device 100 comprising a processing circuit 110, a display module such as a touch-sensitive display module 130, and an audio output module 140. The processing circuit 110 comprises the processing unit 111 and the cache unit 112, configured to perform at least one processing operation and at least one caching operation, respectively. For the case that the processing unit 111 and the cache unit 112 are implemented as the processing unit 111A and the cache unit 112A, respectively, the cache unit 112A can be located outside the processing unit 111A. For the case that the processing unit 111 and the cache unit 112 are implemented as the processing unit 111B and the cache unit 112B, respectively, the cache unit 112B can be located inside the processing unit 111B. Examples of the electronic device 100 may include, but not limited to: a mobile device such as a multifunctional mobile phone.

The electronic device 100 can build, by the processing unit 111, a first command for a first processing stage, where the first command is configured to assign a buffer identifier (ID) to a dedicated-allocated type of target data, and can set, by the cache unit 112, a state of the buffer ID to a dedicated-allocate state to allow (e.g., only) the target data (or the access traffic thereof) to be stored in a cache space (quota) corresponding to the buffer ID. For example, when the state of the buffer ID is set to the dedicated-allocate state, the target data stored in the cache space corresponding to the buffer ID should not be replaced by subsequent data. In addition, the electronic device 100 can build, by the processing unit 111, a second command for a second processing stage, where the second command is configured to change the state of the buffer ID to a released state, and can set, by the cache unit 112, the state of the buffer ID to the released state to allow the target data stored in the cache space (quota) corresponding to the buffer ID to be replaced by subsequent data. For example, the first and the second processing stages are different render passes, and the dedicated-allocated type of target data may comprise a depth image. For example, the second processing stage may be a final render pass using the target data (e.g., the depth image). It is noted that the dedicated-allocated type of target data may comprise all data accessed by one or a combination of a tile buffer and a texture buffer. In some implementations, the target data may be associated with data transfers between on-chip buffers and memory. For example, during tile-based rendering, rendering results may be written from a tile buffer (e.g., an on-chip tile buffer) to a memory, and subsequently read from the memory into a texture buffer (e.g., an on-chip texture buffer) for further processing. Access traffic generated by such write and read operations passes through the cache hierarchy. Accordingly, data accessed by one or a combination of a tile buffer and a texture buffer may be treated as the target data and subject to the dedicated-allocation mechanism in the cache. Additionally, the electronic device 100 may further comprise a memory (not shown in FIG. 1) that is external to the processing circuit 110, and therefore the memory within the electronic device 100 may be regarded as an external memory. Preferably, the memory within the electronic device 100 is implemented by way of a dynamic random access memory (DRAM), and the replaced target data is not written back to the external memory (such as DRAM) or other types of caches with slower access speed.

In the architecture shown in FIG. 1, the processing unit 111 can be a GPU, but the present disclosure is not limited thereto. For example, the processing unit 111 can be an NPU. In particular, the first and the second processing stages may correspond to operations at different layers of a neural network, and the neural network may run on the NPU.

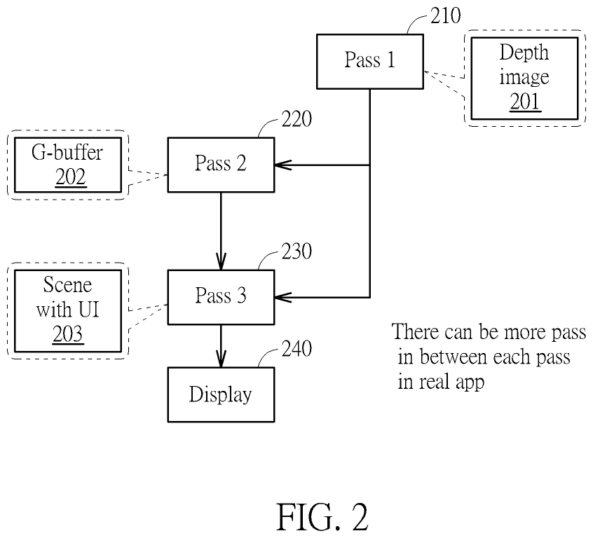

FIG. 2 illustrates a rendering control scheme of the method according to an embodiment of the present disclosure, where a display device can be implemented by way of a touch screen, and can be taken as an example of the touch-sensitive display module 130 shown in FIG. 1. The apparatus such as the electronic device 100 can operate based on the rendering control scheme to optimize the cache usage for processing the target data such as the depth image 201. As shown in FIG. 2, a simple rendering may contain at least three render pass such as Render Passes 1, 2 and 3 (respectively labeled “Pass 1”, “Pass 2” and “Pass 3” for brevity) 210, 220 and 230:
(1) Render Pass 1: draw the depth image 201 (e.g., write data to the memory space of the depth image 201 which may pass though the cache);
(2) Render Pass 2: do some processing based on the depth image 201, where this operation will read content of the depth image 201; and
(3) Render Pass 3: finish the game scene to fit the screen and add one or more UIs for display on the display device (in step 240), where this will be the final usage of the content of the depth image 201, and it will not be used after this pass;
but the present disclosure is not limited thereto. For example, there can be additional passes inserted between these passes in real applications (apps). In this example, the depth image 201 can be used as the target data as mentioned above.

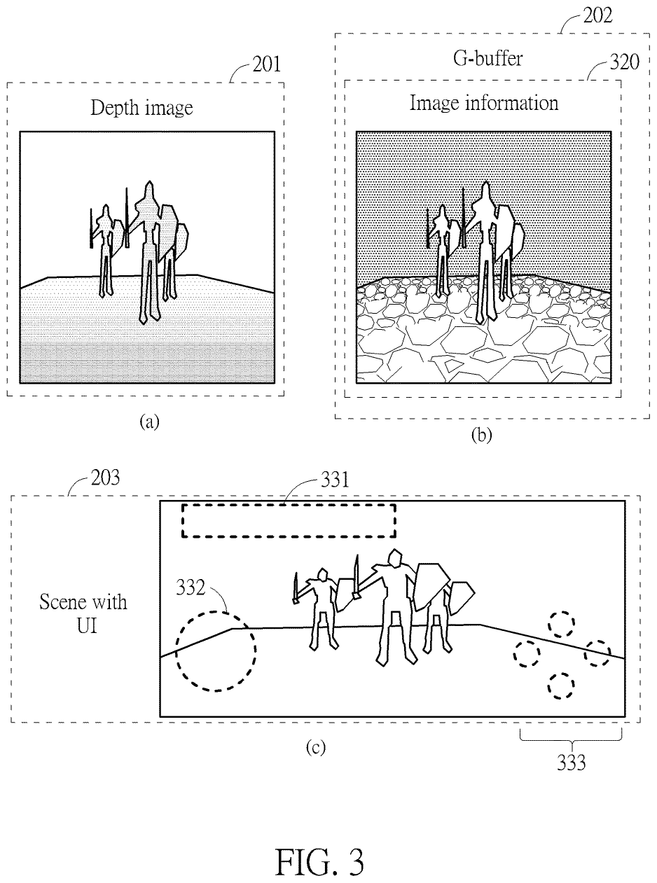

FIG. 3 illustrates some implementation details of the rendering control scheme shown in FIG. 2. In this embodiment, the depth image 201 can be arranged to carry the depths of all objects as shown in the sub-diagram (a) of FIG. 3, and can be taken as an example of the dedicated-allocated type of target data. As shown in the sub-diagram (b) of FIG. 3, the G-buffer 202 used in Render Pass 2 may comprise image information 320, and more particularly, may store the image information 320. For better comprehension, the G-buffer 202 may comprise various attachments such as Albedo/Diffuse, Normal, Metallic/Roughness, Depth, Motion Vector (MV), and Specular. As shown in the sub-diagram (c) of FIG. 3, the scene with UI 203 (e.g., the scene with the one or more UIs) in Render Pass 3 may comprise various UIs 331, 332 and 333 for different purposes. This is for illustrative purposes only, and is not meant to be a limitation of the present disclosure. According to some embodiments, the depth image 201, the image information 320 in the G-buffer 202 as well as the scene with UI 203 and the UIs 331, 332 and 333 therein may vary.

Based on the rendering control scheme in which the dynamic cache control is performed, job-level cache operations can be applied to achieve memory-bandwidth savings through dedicated allocation and discard-after-use behavior. In Render Pass 1, regarding drawing the depth image 201 (i.e., writing the data to the memory space of the depth image 201 though the cache), the cache unit 112 sets the depth image 201 to a dedicated-allocated state, ensuring that no other data can evict it from the cache. In Render Pass 2, regarding doing some processing based on the depth image 201, processing operations that read the depth image 201 are executed. Due to the dedicated allocation, all read accesses obtain cache hits, reducing external memory access. In Render Pass 3, regarding finishing the game scene to fit the screen and add the one or more UIs for display, final scene rendering and UI composition take place. This is the last pass that uses the depth image 201. However, the operation of changing the buffer ID associated with the depth image 201 to the released state is not required to be performed in this render pass. In some embodiments, the buffer ID may be changed to the released state in a subsequent processing stage, as long as the release is scheduled after all accesses to the depth image 201 have been completed, so as to ensure correct access ordering and avoid any access to the depth image 201 after it has been discarded from the cache. After this pass, the depth image 201 becomes unnecessary in the cache. Thus, the corresponding cache quota for the depth image 201 (i.e., the target data) is released, enabling replacement by later data and discarding the released target data without writing it back to other memory (such as the DRAM or other cache unit), which further reduces memory bandwidth.

Preferably, an interface may be provided to allow an upper-layer software component to hint the GPU driver that certain target data requires a buffer ID. The buffer ID is used by the cache unit 114 to determine whether a given access traffic belongs to the dedicated-allocated type of target data. The buffer ID is synchronized to the cache unit 112 through the GPU-Cache interface when the GPU configures properties for a device memory object. For example, this mechanism may be implemented by adding a user-level Application Programming Interface (API) to a graphics or compute language interface (e.g., in Vulkan's vkAllocateMemory call). An application may use such an API to hint the GPU driver that a particular device memory object (also referred to as device memory for brevity) requires assignment of a buffer ID as target data, and the GPU driver may then synchronize the corresponding buffer ID with the cache unit 112. Multiple data objects may share the same buffer ID. In such a case, those data objects may be controlled as a group in the cache. For example, in a Vulkan implementation, multiple images may be bound to the same device memory object. The use of a buffer ID is not restricted to a specific data scope/object. Instead, the buffer ID may also be configured in a channel-wise manner, in which case the dedicated-allocated data may represent all access traffic passing through that channel (e.g., all data accessed by a depth-test unit or all data accessed by a texture unit). In the above embodiment, the timing for assigning a buffer ID is not limited to the memory-allocation stage. For example, a buffer ID may be assigned immediately before the corresponding resource is used (e.g., during resource preparation for a render target, such as during a vkBindImageMemory call).

In addition, an interface may be provided to allow the upper-layer software component to notify a lower layer of the GPU to perform dedicated-allocation and/or release-quota cache operations for target data at the corresponding GPU job. The target data is assumed to already have an assigned buffer ID. For example, this mechanism may be implemented by adding a user-level API to a graphics or compute language interface (e.g., in Vulkan's vkCmdBeginRenderPass call). An application may invoke such an API for notifying the GPU driver while recording render, compute, transfer, or neural-processing commands, allowing the corresponding driver (e.g., GPU driver) to generate the corresponding cache-control command. The timing of sending/issuing a cache-control command is not limited to the command-recording stage. For instance, a cache-control command may also be sent/issued immediately before the GPU executes an action command (e.g., during a Vulkan vkQueueSubmit call). After the cache quota of the target data is released, the buffer-ID setting remains stored in the data-property table, allowing later accesses to the target data to be dedicated-allocated in the cache again (e.g., when an application draws to the same image every frame). The buffer-ID setting is cleared only when the corresponding device memory object is reclaimed by the application, after which the buffer ID may be reused for other data. If multiple data objects are designated for dedicated allocation and attempt to occupy the cache simultaneously while the available cache size is insufficient to accommodate all of them, cache replacement may occur. The following describes one example of a replacement behavior, and the present disclosure is not limited thereto:
(1) replacement between dedicated-allocated data does not use the discard operation;
(2) the later dedicated-allocation request may flush out a portion of the earlier one, causing partial write-back to memory; and
(3) after the replacement, the earlier data may remain partially cached, whereas the later data becomes fully cached.

It should be noted that the above replacement behavior is provided as an example for illustration purposes. Other replacement policies may also be applied when the cache size is insufficient, depending on implementation requirements. For example, in some implementations, earlier dedicated-allocated data may be retained in the cache while later dedicated-allocated data is prevented from occupying the cache space already occupied by earlier dedicated allocated data, or alternative replacement strategies may be employed without departing from the spirit and scope of the present disclosure.

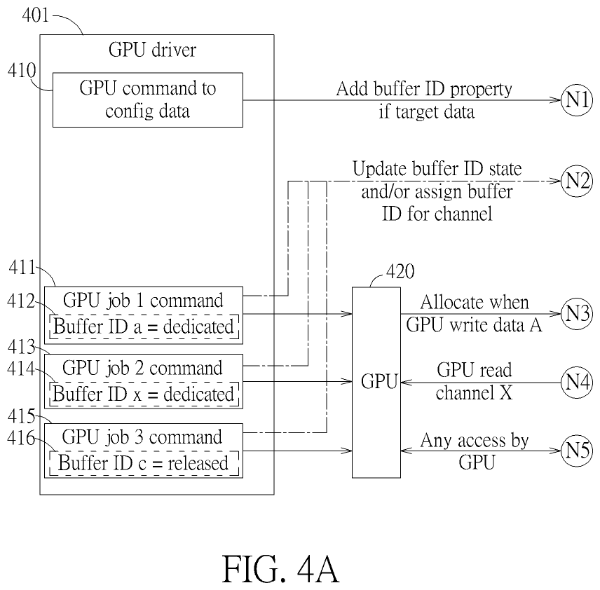

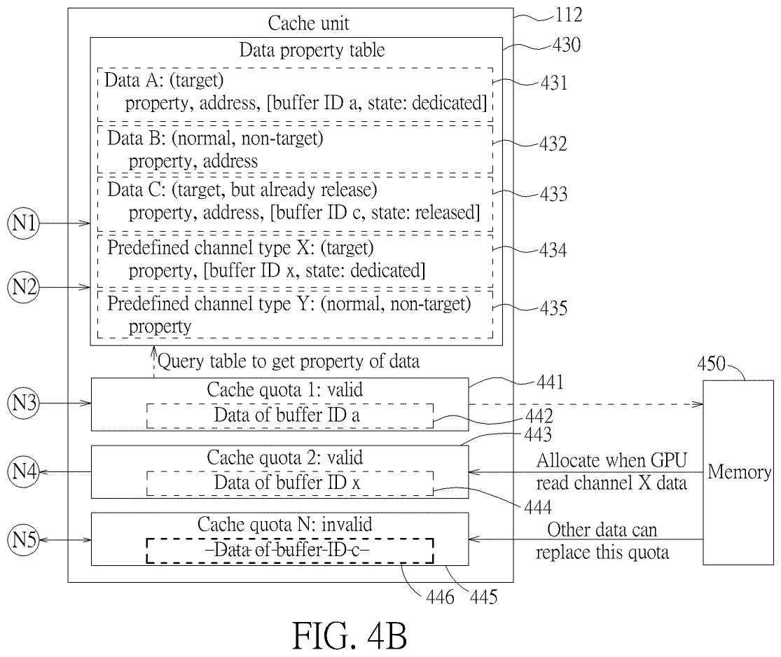

FIG. 4A illustrates the respective operations of the GPU 420 and the GPU driver 401 thereof in a cache quota management control scheme of the method according to an embodiment of the present disclosure, and FIG. 4B illustrates some operations of the cache unit 112 (e.g., the cache unit 112A/112B as shown in FIG. 1) with respect to the memory 450 in the cache quota management control scheme shown in FIG. 4A, where the arrows for indicating the interactions between the GPU driver 401 and the GPU 420 shown in FIG. 4A and the cache unit 112 shown in FIG. 4B can be connected via the nodes N1 to N5. The processing unit 111 and the external memory can be implemented as the GPU 420 and the memory 450 in this embodiment, respectively.

The GPU driver 401 can bind resources for GPU commands to configure (or “config”) the associated data properties (labeled “GPU commands to config data” for brevity) in the operation 410, and more particularly, can control the cache unit 112 to add a buffer ID property if it is the case of target data (in other words, the resource corresponds to target data). The cache unit 112 may maintain a data property table 430, which records property information for each data object or predefined channel type. In one example implementation, the data-property table 430 may comprise multiple data-property entries such as the entries 431, 432, 433, 434 and 435 for Data A (target data), Data B (normal, non-target data), Data C (target data, but already released), Predefined channel type X (target channel) and Predefined channel type Y (normal, non-target channel), respectively. Regarding Data A (target data), the entry 431 comprises the property information and the memory address of Data A, as well as a buffer-ID field assigned with the buffer ID a, along with a state field indicating that Data A is in the dedicated state (i.e., the dedicated-allocate state mentioned above). Regarding Data B (normal, non-target data), the entry 432 comprises the property information and the memory address of Data B. Since Data B is not target data, no buffer-ID field or state field is present. Regarding Data C (target data, but already released), the entry 433 comprises the property information and the memory address of Data C, as well as a buffer-ID field assigned with the buffer ID c, and a state field indicating that Data C is in the released state. Regarding Predefined channel type X (target channel), the entry 434 comprises the property information for the predefined channel type X, as well as a buffer-ID field assigned with the buffer ID x, and a state field indicating the dedicated state. In this case, the target data corresponds to all access traffic belonging to this channel type. Regarding Predefined channel type Y (normal, non-target channel), the entry 435 comprises the property information for predefined channel type Y. Since this channel type is not designated as target data, no buffer-ID or state field is included.

In addition, the GPU driver 401 can control the cache unit 112 to update the buffer ID state and/or to assign a buffer ID for a channel, and the cache unit 112 may query the data property table 430 to get/obtain the property information of the corresponding data. For example, the associated operations may comprise:
(1) In response to the GPU job 1 command 411, with the buffer ID 412 such as the buffer ID a having the state “dedicated” (labeled “Buffer ID a=dedicated” for brevity), the GPU 420 writes data A, and the cache unit 112 allocates cache space corresponding to the cache quota 441 such as Cache quota 1 for this data, where the cache quota 441 such as Cache quota 1 is set as valid, and the stored content 442 in the cache space corresponding to the cache quota 441 is the data associated with buffer ID a (labeled “Data of buffer ID a” for brevity);
(2) In response to the GPU job 2 command 413, with the buffer ID 414 such as the buffer ID x having the state “dedicated” (labeled “Buffer ID x=dedicated” for brevity), the GPU 420 reads data associated with channel type X from the memory 450, and the cache unit 112 allocates cache space corresponding to the cache quota 443 such as Cache quota 2 when the GPU 420 reads the channel-X data, where the cache quota 443 such as Cache quota 2 is set as valid, and the stored content 444 in the cache space corresponding to the cache quota 443 is the data associated with buffer ID x (labeled “Data of buffer ID x” for brevity); and
(3) In response to the GPU job 3 command 415, with the buffer ID 416 such as the buffer ID c having the state “released” (labeled “Buffer ID c=released” for brevity), any type of GPU access (e.g., any access by the GPU 420) may occur, and because the buffer ID state is “released” as shown in the data property table 430, the cache quota 445 such as Cache quota N for the stored content 446 such as the data associated with buffer ID c becomes invalid, and therefore, the data associated with buffer ID c (labeled “Data of buffer ID c” for brevity) may be discarded, which is illustrated in FIG. 4B by a dashed strike-through line for clarity, where other data can replace this quota (i.e., the cache quota corresponding to buffer ID c) under control of the cache unit 112, regardless of whether the access traffic of the other data is generated by the GPU, the memory, or any other processing or memory access source that traverses the cache.

In the above embodiment, the cache quota may refer to a logical allocation associated with the data's usage of the cache space. The cache space corresponding to the cache quota may store the target data when the data is in the dedicated state. In addition, in the data property table 430, a data-property entry that includes an additional buffer ID property (or “buffer-ID property”) is considered as target, indicating that the data with the additional buffer-ID property is considered target data. Once the cache unit 112 identifies access traffic belonging to the target data, it marks the corresponding buffer ID on the cache quota. The initial state of a buffer ID is the “released” state. The channel types are predefined with a limited count, and the buffer IDs associated with these channel types may be updated later in accordance with the GPU job being executed.

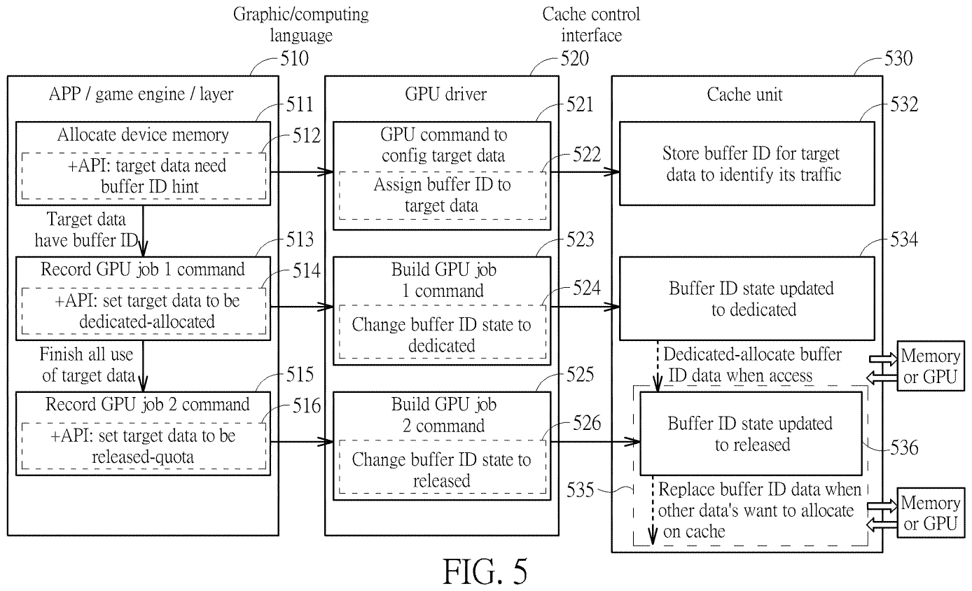

FIG. 5 illustrates a basic case control scheme of the method according to an embodiment of the present disclosure, where the GPU driver 520 and the cache unit 530 can be taken as examples of the GPU driver 401 and the cache unit 112, respectively, and can operate under control of the upper-layer software component, such as the upper-layer software stack 510 including but not limited to an application, a game engine, and/or a graphics or compute API layer (labeled “APP/game engine/layer” for brevity) that is capable of issuing commands to the GPU driver 520. As shown in FIG. 5, the upper-layer software stack 510 may issue GPU commands to the GPU driver 520 via an upper-layer graphics or compute language interface (e.g., Vulkan), and the GPU driver 520 may interpret these commands and communicate with the cache unit 530 through a lower-layer cache-control interface, by which buffer-ID settings and cache-control states (e.g., dedicated state or released state) are delivered to the cache unit 530.

As further illustrated in FIG. 5, the upper-layer software stack 510 may perform a sequence of operations 511, 513, and 515. Each of these operations may include a corresponding API-level sub-operation, illustrated as operations 512, 514, and 516, respectively. The operation 511 represents the allocation of device memory object by the upper-layer software stack 510, and the internal sub-operation 512 (shown as “+API: target data need buffer ID hint”) allows the upper-layer software stack 510 to issue an API-level indication that the allocated device memory object corresponds to target data requiring a buffer ID. The operation 513 represents the recording of the GPU Job 1 command, and the internal sub-operation 514 (shown as “+API: set target data to be dedicated-allocated”) enables the upper-layer software stack 510 to invoke an API that requests the GPU driver 520 to set the buffer-ID state of the target data to the dedicated state for Job 1. The operation 515 represents the recording of the GPU Job 2 command, which occurs after all uses of the target data in Job 1 have been completed, and the internal sub-operation 516 (shown as “+API: set target data to be released-quota”) enables the upper-layer software stack 510 to invoke an API to request that the buffer-ID state of the target data be changed to the released state for the GPU Job 2. The arrows labeled “Target data have buffer ID” and “Finish all use of target data” indicate the logical progression between the above operations, namely that the target data has acquired a buffer ID between operations 511 and 513, and that all uses of the target data have been completed between operations 513 and 515.

In addition, the GPU driver 520 may perform a sequence of operations 521, 523, and 525 in correspondence with the upper-layer operations such as the operations 511, 513, and 515. Each of the GPU-driver operations such as the operations 521, 523, and 525 includes a respective internal sub-operation, illustrated as operations 522, 524, and 526. The operation 521 represents a configuration stage in which the GPU driver 520 receives an indication from the operation 511 that the corresponding resource is target data (labeled “GPU command to config target data” for brevity), and the internal sub-operation 522 (shown as “Assign buffer ID to target data”) configures the data properties within the GPU driver 520 by assigning a buffer ID to the target data, such that the buffer-ID information can later be synchronized with the cache unit 530. The operation 523 for building the GPU Job 1 command receives its input from the operation 513, which indicates that the GPU Job 1 is being recorded and that the target data should be placed in the dedicated state, and the internal sub-operation 524 (shown as “Change buffer ID state to dedicated”) enables the GPU driver 520 to build the GPU Job 1 command together with a cache-control command that sets the buffer-ID state of the target data to dedicated. The operation 525 for building the GPU Job 2 command receives its input from operation 515, which indicates that all uses of the target data have been completed and that the target data should be released, and the internal sub-operation 526 (shown as “Change buffer ID state to released”) enables the GPU driver 520 to build the GPU Job 2 command together with the corresponding cache-control command that sets the buffer-ID state of the target data to released. The arrows from the operations 511, 513, and 515 to the operations 521, 523, and 525 respectively indicate the propagation of upper-layer intent to the GPU driver 520. Specifically, the operation 511 triggers the operation 521 to assign the buffer ID, the operation 513 triggers the operation 523 to set the dedicated state for Job 1, and the operation 515 triggers the operation 525 to set the released state for Job 2.

Additionally, the cache unit 530 may perform a sequence of operations 532, 534, and 536 in correspondence with the GPU-driver operations such as the operations 521, 523, and 525, respectively. In the operation 532, the cache unit 530 receives an indication from the operation 521, and stores the buffer ID associated with the target data to subsequently identify whether an access traffic belongs to the target data. In the operation 534, the cache unit 530 receives an indication from the operation 523, for informing the cache unit 530 that the buffer ID has transitioned to the dedicated state, and maintains the buffer-ID state to be updated to “dedicated” (for example, in the data property table 430 shown in FIG. 4B, for the case that the cache unit 530 is taken as an example of the cache unit 112). An arrow labeled “Dedicated-allocate buffer ID data when access” from the operation 534 to the operation 536 indicates that, upon the GPU or memory access traffic, the cache unit 530 may allocate the cache space corresponding to the cache quota for the buffer-ID-associated data. For example, such dedicated allocation may involve input/output (I/O) interactions between the cache unit 530 and any one of the GPU and the external memory (e.g., the GPU 420 and the memory 450 respectively shown in FIG. 4A and FIG. 4B). In the operation 536, the cache unit 530 receives an indication from the operation 525, for informing the cache unit 530 that the buffer ID has transitioned to the released state, and maintains the buffer-ID state to be updated to “released” (for example, in the data property table 430 shown in FIG. 4B, given that the cache unit 530 is taken as an example of the cache unit 112). Once in this state, referred to as the state 535, the associated cache quota becomes eligible for replacement. An outward arrow labeled “Replace buffer ID data when other data's want to allocate on cache” from the operation 536 indicates that the cache unit 530 may replace the data associated with the released buffer ID when other data requests cache allocation. This replacement process may involve I/O interactions between the cache unit 530 and any one of the GPU and the external memory (e.g., the GPU 420 and the memory 450 mentioned above), in particular, depending on whether the data is discarded or written back.

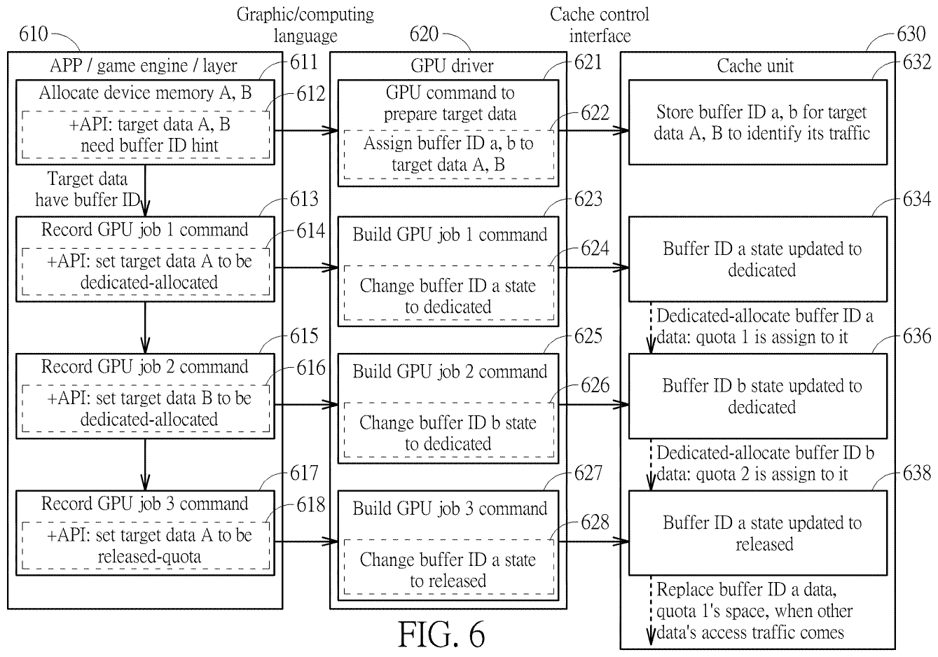

FIG. 6 illustrates a multiple data control scheme of the method according to an embodiment of the present disclosure, where the GPU driver 620 and the cache unit 630 can be taken as examples of the GPU driver 401 and the cache unit 112, respectively, and can operate under control of the upper-layer software component, such as the upper-layer software stack 610 including but not limited to the application, the game engine, and/or the graphics or compute API layer (labeled “APP/game engine/layer” for brevity) that is capable of issuing commands to the GPU driver 620. As shown in FIG. 6, the upper-layer software stack 610 may issue GPU commands to the GPU driver 620 via an upper-layer graphics or compute language (e.g., Vulkan), and the GPU driver 620 may interpret these commands and communicate with the cache unit 630 through a lower-layer cache-control interface, by which buffer-ID settings and cache-control states (e.g., dedicated or released) are delivered to the cache unit 630.

As further illustrated in FIG. 6, the upper-layer software stack 610 may perform a sequence of operations 611, 613, 615, and 617, each having a corresponding API-level sub-operation 612, 614, 616, and 618, respectively. These operations illustrate a multiple-data control scenario in which the target data A and the target data B are independently dedicated-allocated and released. The operation 611 represents the allocation of device memory object for data A and data B, and the internal sub-operation 612 (shown as “+API: target data A, B need buffer ID hint”) enables the upper-layer software stack 610 to issue API-level hints indicating that both the data A and the data B require assignment of buffer IDs as target data. An arrow (labeled “Target data have buffer ID”) from the operation 611 to the operation 613 indicates that the buffer IDs for both the data A and the data B are assigned prior to the recording of the GPU Job 1. The operation 613 represents the recording of the GPU Job 1, and the internal sub-operation 614 (shown as “+API: set target data A to be dedicated-allocated”) enables the upper-layer software stack 610 to request that the buffer-ID state of the data A be set to the dedicated state for execution of the GPU Job 1. The operation 615 represents the recording of the GPU Job 2, and the internal sub-operation 616 (shown as “+API: set target data B to be dedicated-allocated”) enables the upper-layer software stack 610 to request that the buffer-ID state of the data B be set to the dedicated state for execution of the GPU Job 2. This demonstrates that the data A and the data B may be independently dedicated-allocated at different GPU jobs. The operation 617 represents the recording of the GPU Job 3, and the internal sub-operation 618 (shown as “+API: set target data A to be released-quota”) enables the upper-layer software stack 610 to request that the buffer-ID state of the data A be transitioned to the released state, indicating that all uses of the data A have been completed and its cache quota is eligible for replacement.

In addition, the GPU driver 620 may perform a sequence of operations 621, 623, 625, and 627 in correspondence with the upper-layer operations such as the operations 611, 613, 615, and 617, respectively. Each of these GPU-driver operations such as the operations 621, 623, 625, and 627 includes a respective internal sub-operation, illustrated as operations 622, 624, 626, and 628. The operation 621 for preparing target data with respect to the GPU commands (labeled “GPU command to prepare target data” for brevity) receives its input from the operation 611, which indicates that the device memories for the data A and the data B have been allocated and identified as target data, and the internal sub-operation 622 (shown as “Assign buffer ID a, b to target data A, B”) represents configuring the GPU-driver data-property entries to assign the buffer ID a to the data A and the buffer ID b to the data B. These buffer IDs may later be synchronized with the cache unit 630. The operation 623 for building the GPU Job 1 command receives its input from the operation 613, which indicates that the GPU Job 1 is being recorded and that the data A should be placed in the dedicated state for this job, and the internal sub-operation 624 (shown as “Change buffer ID a state to dedicated”) enables the GPU driver 620 to generate the GPU Job 1 command together with a corresponding cache-control command that sets the buffer-ID state of data A to dedicated. The operation 625 for building the GPU Job 2 command receives its input from operation 615, which indicates that the GPU Job 2 is being recorded and that the data B should be placed in the dedicated state for this job, and the internal sub-operation 626 (shown as “Change buffer ID b state to dedicated”) enables the GPU driver 620 to generate the GPU Job 2 command together with the corresponding cache-control command that sets the buffer-ID state of the data B to dedicated. The operation 627 for building the GPU Job 3 command receives its input from operation 617, which indicates that all uses of the data A have been completed and its cache quota should be released, and the internal sub-operation 628 (shown as “Change buffer ID a state to released”) enables the GPU driver 620 to generate the GPU Job 3 command together with a cache-control command that sets the buffer-ID state of the data A to released.

The arrows from the operations 611, 613, 615, and 617 to the operations 621, 623, 625, and 627 indicate that the upper-layer intent is propagated to the GPU driver 620. Specifically, the operation 611 triggers the buffer-ID assignment in the operation 621, the operation 613 triggers the dedicated allocation for the data A in the operation 623, the operation 615 triggers the dedicated allocation for the data B in the operation 625, and the operation 617 triggers the release of the data A in the operation 627.

Additionally, the cache unit 630 may perform a sequence of operations 632, 634, 636, and 638 in correspondence with the GPU-driver operations such as the operations 621, 623, 625, and 627, respectively. Each operation reflects how the cache unit 630 interprets the buffer-ID assignments and the buffer-ID state updates for the target data A and B. In the operation 632, the cache unit 630 receives indications from the operation 621, and the cache unit 630 stores the buffer ID a for the data A and the buffer ID b for the data B to subsequently identify the traffic thereof, and more particularly, to identify whether the incoming access traffic corresponds to the target data A or the target data B. In the operation 634, the cache unit 630 receives an indication (e.g., an update) from the operation 623, for informing the cache unit 630 that the buffer ID a has transitioned to the dedicated state for the GPU Job 1, and maintains the buffer ID a state such as the state of the buffer ID a to be updated to “dedicated” (for example, in the data property table 430 shown in FIG. 4B, for the case that the cache unit 630 is taken as an example of the cache unit 112). An arrow labeled “Dedicated-allocate buffer ID a data: quota 1 is assigned to it” from the operation 634 to the operation 636 indicates that, upon the access traffic belonging to the buffer ID a, the cache unit 630 may allocate the cache space corresponding to the cache quota 1 and store the corresponding data in that space. For example, such dedicated allocation may involve I/O interactions between the cache unit 630 and any one of the GPU and the external memory (e.g., the GPU 420 and the memory 450 respectively shown in FIG. 4A and FIG. 4B). In the operation 636, the cache unit 630 receives an indication (e.g., an update) from the operation 625, for informing the cache unit 630 that the buffer ID b has transitioned to the dedicated state for the GPU Job 2, and maintains the buffer ID b state such as the state of the buffer ID b to be updated to “dedicated” (for example, in the data property table 430 shown in FIG. 4B, given that the cache unit 630 is taken as an example of the cache unit 112). An arrow labeled “Dedicated-allocate buffer ID b data: quota 2 is assigned to it” from the operation 636 to the operation 638 indicates that, for the access traffic corresponding to the buffer ID b, the cache unit 630 may allocate the cache space corresponding to the cache quota 2 and store the corresponding data in that space. For example, such dedicated allocation may involve I/O interactions between the cache unit 630 and any one of the GPU and the external memory (e.g., the GPU 420 and the memory 450 respectively shown in FIG. 4A and FIG. 4B). This illustrates that multiple target data objects such as the data A and B may be dedicated-allocated independently and may occupy separate cache quotas at the same time. In the operation 638, the cache unit 630 receives an indication (e.g., an update) from the operation 627, for informing the cache unit 630 that the buffer ID a has transitioned to the released state for the GPU Job 3, and maintains the buffer ID a state such as the state of the buffer ID a to be updated to “released” (for example, in the data property table 430 shown in FIG. 4B, in a situation where the cache unit 630 is taken as an example of the cache unit 112). Once the buffer-ID state is “released” (i.e., the released state), the associated cache quota such as the quota 1 becomes eligible for replacement. An outward arrow labeled “Replace buffer ID a data, quota 1's space, when other data's access traffic comes” from the operation 638 indicates that the cache unit 630 may replace the buffer ID a data stored in the cache space corresponding to the quota 1 with other data that requests cache allocation. This replacement process may involve I/O interactions between the cache unit 630 and any one of the GPU and the external memory (e.g., the GPU 420 and the memory 450 mentioned above), in particular, depending on discard or write-back behavior.

Furthermore, the dedicated-allocation mechanism is not restricted to a single buffer ID or limited to a single job scope. For example, when a GPU job carries access traffic of multiple target data objects, the buffer IDs associated with those data objects (e.g., the buffer ID a and the buffer ID b) may be simultaneously configured in the dedicated state, such that their corresponding data is concurrently allocated into the cache, each occupying a respective cache quota. In other words, the dedicated-allocation assignment is not exclusive to a single job or a single buffer ID. For example, during the interval corresponding to the operations 636 to 638 in FIG. 6, the buffer ID a and the buffer ID b may both remain in the dedicated state concurrently, allowing the access traffic of the data A and the data B to be simultaneously allocated into separate cache quotas.

In the above embodiment, if the cache is large enough for the data A and B, for example, when the cache capacity is sufficient to accommodate both the data objects such as the data A and the data B, each of these data objects remains fully dedicated in the cache, and their cache usage does not overlap. However, if the cache capacity is insufficient to hold both the data objects such as the data A and the data B simultaneously, cache replacement may occur according to an implementation-dependent replacement policy. In one example, the later-dedicated data B may partially flush out the cache space corresponding to data A, causing a portion of data A to be written back to the memory 450. Because a partial flush occurs in this example, the data A may not obtain the full benefit of discard-after-use functionality.

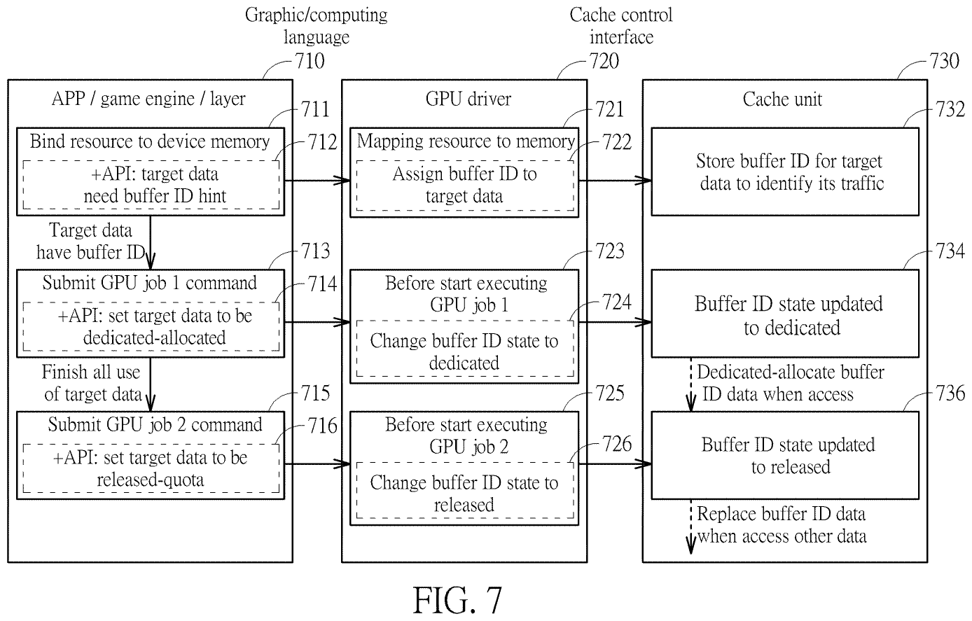

FIG. 7 illustrates a configuring timing control scheme of the method according to an embodiment of the present disclosure, where the GPU driver 720 and the cache unit 730 can be taken as examples of the GPU driver 401 and the cache unit 112, respectively, and can operate under control of the upper-layer software component, such as the upper-layer software stack 710 including but not limited to the application, the game engine, and/or the graphics or compute API layer (labeled “APP/game engine/layer” for brevity) that is capable of issuing commands to the GPU driver 720. As shown in FIG. 7, the upper-layer software stack 710 may issue GPU commands to the GPU driver 720 via an upper-layer graphics or compute language (e.g., Vulkan), and the GPU driver 720 may interpret these commands and communicate with the cache unit 730 through a lower-layer cache-control interface, by which buffer-ID settings and cache-control states (e.g., dedicated or released) are delivered to the cache unit 730.

As further illustrated in FIG. 7, the upper-layer software stack 710 may perform a sequence of operations 711, 713, and 715, each having a corresponding API-level sub-operation, illustrated as operations 712, 714, and 716, respectively. These operations demonstrate the alternative configuration-timing control in which the buffer-ID assignment and the state transitions occur at the command-submission time rather than at the command-record time. The operation 711 represents the stage in which the upper-layer software stack 710 binds a resource (e.g., an image or buffer) to a device-memory allocation, and the internal sub-operation 712 (shown as “+API: target data need buffer ID hint”) enables the upper-layer software stack 710 to issue an API-level hint that the bound resource corresponds to the target data requiring assignment of a buffer ID. An arrow labeled “Target data have buffer ID” from the operation 711 to the operation 713 indicates that the target data acquires a buffer ID before the GPU Job 1 is submitted. The operation 713 represents the submission of the GPU Job 1 command by the upper-layer software stack 710, and the internal sub-operation 714 (shown as “+API: set target data to be dedicated-allocated”) allows the upper-layer software stack 710 to invoke an API requesting that the buffer-ID state of the target data be set to the dedicated state for execution of the GPU Job 1. The operation 715 represents the submission of the GPU Job 2 command by the upper-layer software stack 710, and the internal sub-operation 716 (shown as “+API: set target data to be released-quota”) enables the upper-layer software stack 710 to request that the buffer-ID state of the target data be transitioned to the released state after all uses of the target data have been completed. An arrow labeled “Finish all use of target data” from the operation 713 to the operation 715 indicates that the GPU Job 2 command is submitted after the upper-layer software stack 710 determines that all accesses to the target data in Job 1 command have been completed.

In addition, the GPU driver 720 may perform a sequence of operations 721, 723, and 725 in correspondence with the upper-layer operations such as the operations 711, 713, and 715, respectively. Each of the GPU-driver operations such as any of the operations 721, 723, and 725 includes an internal sub-operation, illustrated as operations 722, 724, and 726. The operation 721 for mapping resource to memory receives its input from the operation 711, which indicates that a resource has been bound to the device memory object and identified as the target data, and the internal sub-operation 722 (shown as “Assign buffer ID to target data”) represents configuring the GPU-side data property so that the target data is assigned a buffer ID. This buffer-ID information may subsequently be used by the cache unit 730 when performing cache-control operations. The operation 723 such as an operation before starting executing GPU Job 1 (labeled “Before start executing GPU job 1” for brevity) receives its input from the operation 713, which indicates that the GPU Job 1 is about to begin execution, and the internal sub-operation 724 (shown as “Change buffer ID state to dedicated”) enables the GPU driver 720 to update the buffer-ID state of the target data to the dedicated state before issuing GPU Job 1 to execution. This state information is then communicated to the cache unit 730 through the cache-control interface. The operation 725 such as an operation before starting executing the GPU Job 2 (labeled “Before start executing GPU job 2” for brevity) receives its input from the operation 715, which indicates that all uses of the target data for the Job 1 have been completed and that the GPU Job 2 is about to begin, and the internal sub-operation 726 (shown as “Change buffer ID state to released”) enables the GPU driver 720 to update the buffer-ID state of the target data to the released state prior to executing the GPU Job 2. As a result, the corresponding cache quota may become eligible for replacement.

Arrows from the operations 711, 713, and 715 toward the operations 721, 723, and 725 respectively indicate that the upper-layer timing signals trigger the corresponding GPU-driver updates. Specifically, the operation 711 triggers the buffer-ID assignment in the operation 721, the operation 713 triggers the dedicated allocation for the Job 1 in the operation 723, and the operation 715 triggers the release-state setting for the Job 2 in the operation 725.

Additionally, the cache unit 730 may perform a sequence of operations 732, 734, and 736 in correspondence with the GPU-driver operations 721, 723, and 725, respectively. These operations demonstrate how the cache unit 730 applies the buffer-ID assignments and the buffer-ID state transitions during command-submission-time control. In the operation 732, the cache unit 730 receives an indication from the operation 721, and stores the buffer ID assigned to the target data to subsequently identify its traffic, and more particularly, determine whether any incoming access traffic belongs to the target data. In the operation 734, the cache unit 730 receives an indication (e.g., an update) from the operation 723, for informing the cache unit 730 that the buffer ID for the target data has transitioned to the dedicated state, and maintains the buffer-ID state to be updated to “dedicated” (for example, in the data property table 430 shown in FIG. 4B, for the case that the cache unit 730 is taken as an example of the cache unit 112). An arrow labeled “Dedicated-allocate buffer-ID data when access” from the operation 734 to operation 736 indicates that when the access traffic corresponding to the buffer ID is detected, the cache unit 730 may allocate the cache space in response, storing the buffer-ID-associated data within the corresponding cache quota. For example, such dedicated allocation may involve I/O interactions between the cache unit 730 and any one of the GPU and the external memory (e.g., the GPU 420 and the memory 450 respectively shown in FIG. 4A and FIG. 4B). In the operation 736, the cache unit 730 receives an indication (e.g., an update) from the operation 725, for informing the cache unit 730 that the buffer ID has transitioned to the released state, and maintains the buffer-ID state to be updated to “released” (for example, in the data property table 430 shown in FIG. 4B, given that the cache unit 730 is taken as an example of the cache unit 112). Once in this state, the cache quota for the buffer-ID-associated data becomes eligible for replacement. An outward arrow labeled “Replace buffer ID data when access other data” from the operation 736 indicates that the cache unit 730 may replace the cache space corresponding to the released buffer-ID data when the access traffic from other data requests cache allocation. This replacement process may involve I/O interactions between the cache unit 730 and any one of the GPU and the external memory (e.g., the GPU 420 and the memory 450 mentioned above), in particular, depending on discard or write-back behavior.

It should also be noted that the timing for configuring the GPU driver 720 and the cache unit 730 is not limited to the embodiment described in FIG. 7. In practice, the configuration timing of the buffer-ID settings and the cache-control operations, such as the timing at which the GPU driver 720 configures the buffer-ID settings and the timing at which the cache unit 730 applies the corresponding cache-control operations, may vary depending on the specific implementation of the GPU driver, the graphics or compute API layer, or the underlying hardware architecture.

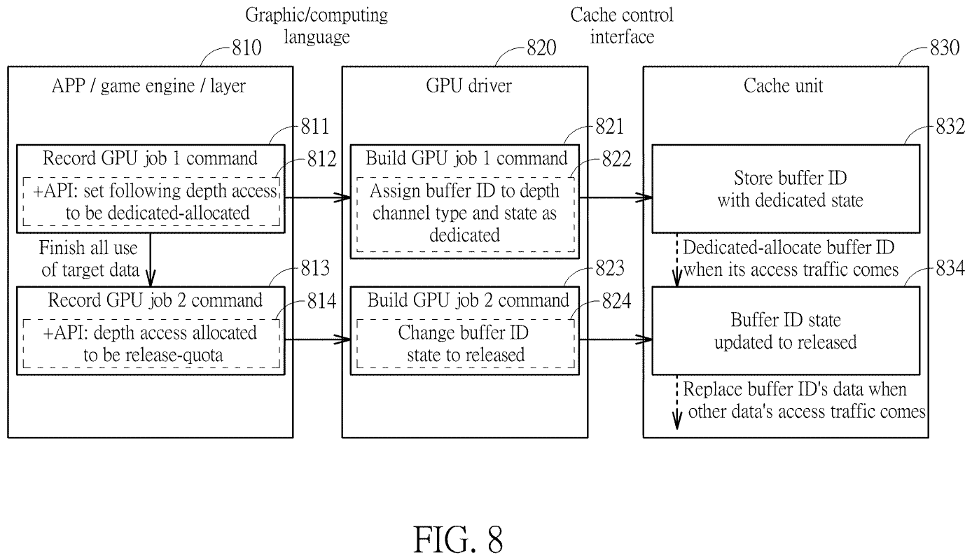

FIG. 8 illustrates a channel-wise control scheme of the method according to an embodiment of the present disclosure, where the GPU driver 820 and the cache unit 830 can be taken as examples of the GPU driver 401 and the cache unit 112, respectively, and can operate under control of the upper-layer software component, such as the upper-layer software stack 810 including but not limited to the application, the game engine, and/or the graphics or compute API layer (labeled “APP/game engine/layer” for brevity) that is capable of issuing commands to the GPU driver 820. As shown in FIG. 8, the upper-layer software stack 810 may issue GPU commands to the GPU driver 820 via an upper-layer graphics or compute language (e.g., Vulkan), and the GPU driver 820 may interpret these commands and communicate with the cache unit 830 through a lower-layer cache-control interface, by which buffer-ID settings and cache-control states (e.g., dedicated or released) are delivered to the cache unit 830.

As further illustrated in FIG. 8, the upper-layer software stack 810 may perform a sequence of operations 811 and 813, each having a corresponding API-level sub-operation, illustrated as operations 812 and 814, respectively. This embodiment demonstrates the channel-wise control in which cache control is applied based on a predefined channel type (e.g., depth-access traffic), rather than on a per-data basis. In the channel-wise case, a buffer ID is not assigned to a specific data object. Instead, the buffer ID may be assigned later in accordance with the associated GPU job. There is no need to update the data property table 430 first since the buffer ID is not limit to specific data. For example, the dedicated-allocation behavior may apply to all access traffic of the specified channel type, but the present disclosure is not limited thereto. In particular, the operation 811 represents the stage where the upper-layer software stack 810 records the GPU Job 1 command, and the internal sub-operation 812 (shown as “+API: set following depth access to be dedicated-allocated”) enables the upper-layer software stack 810 to issue an API-level request indicating that all subsequent traffic including but not limited to the depth-access traffic for the GPU Job 1 should be treated as dedicated-allocated in the cache unit 830. In this channel-wise configuration, the dedicated state applies to the entire access channel (e.g., depth test unit accesses), rather than a specific data object. The operation 813 represents the stage where the upper-layer software stack 810 records the GPU Job 2 command, and the internal sub-operation 814 (shown as “+API: depth access allocated to be released-quota”) allows the upper-layer software stack 810 to issue an API-level request that the channel-wise buffer-ID state for depth-access traffic be transitioned to the released state. An arrow labeled “Finish all use of target data” from the operation 811 to the operation 813 indicates that the GPU Job 2 is recorded after all depth-access operations requiring the dedicated allocation have been completed in the Job 1.

In addition, the GPU driver 820 may perform a sequence of operations 821 and 823 in correspondence with the upper-layer operations such as the operations 811 and 813, respectively. Each of these GPU-driver operations such as the operations 821 and 823 includes an internal sub-operation, illustrated as operations 822 and 824. The operation 821 for building the GPU Job 1 command receives its input from the operation 811, which indicates that the GPU Job 1 has been recorded by the upper-layer software stack 810 and that the subsequent depth-access traffic should be dedicated-allocated, and the internal sub-operation 822 (shown as “Assign buffer ID to depth channel type and state as dedicated”) enables the GPU driver 820 to assign a buffer ID to the depth-access channel type and to set the corresponding buffer-ID state to the dedicated state for execution of the GPU Job 1.This channel-wise configuration allows the cache unit 830 to treat depth-access traffic based on the buffer-ID state, such that all depth-access traffic occurring after the buffer ID is set to the dedicated state (e.g., by the Job 1) and before the buffer ID is changed to the released state (e.g., by the Job 2) is treated as dedicated-allocated. The jobs that configure the dedicated state and the released state are not required to be consecutive, and depth-access traffic generated by intervening jobs may also be subject to the same policy. The operation 823 for building the GPU Job 2 command receives its input from the operation 813, which indicates that the upper-layer software stack 810 has completed all uses of the depth-access traffic requiring the dedicated allocation and that the GPU Job 2 is being recorded, and the internal sub-operation 824 (shown as “Change buffer ID state to released”) enables the GPU driver 820 to generate the GPU Job 2 command together with a cache-control command that transitions the depth-channel buffer-ID state to the released state. As a result, the cache quota associated with the depth-access traffic becomes eligible for replacement by other data.

Arrows from the operations 811 and 813 toward the operations 821 and 823 indicate that the upper-layer configuration of the channel-wise cache behavior is propagated to the GPU driver 820. The operation 811 triggers the dedicated-channel configuration in the operation 821, whereas the operation 813 triggers the released-channel configuration in the operation 823.

Additionally, the cache unit 830 may perform a sequence of operations 832 and 834 in correspondence with the GPU-driver operations such as the operations 821 and 823, respectively. These operations demonstrate how the channel-wise buffer-ID control is applied within the cache unit 830 when the buffer ID is assigned to a channel type rather than to a specific data object. Before the operation 832, it is noted that, in the channel-wise case, there is no need to update the data-property table initially, because the buffer ID is not limited to a specific data object. Instead, the buffer ID may be applied to all access traffic of the corresponding channel type as GPU jobs are issued. In the operation 832, the cache unit 830 receives an indication from the operation 821, which may assign a buffer ID to the depth-access channel type and sets its state to the dedicated state, and stores the buffer ID together with its dedicated state, enabling the cache unit 830 to recognize when incoming access traffic belongs to that channel type. An arrow labeled “Dedicated-allocate buffer ID when its access traffic comes” from the operation 832 to the operation 834 indicates that when access traffic corresponding to the designated channel type is detected, the cache unit 830 may allocate cache space for the channel-wise buffer-ID data under the dedicated-allocation policy. For example, such allocation may involve I/O interactions between the cache unit 830 and any one of the GPU and the external memory (e.g., the GPU 420 and the memory 450 respectively shown in FIG. 4A and FIG. 4B). In the operation 834, the cache unit 830 receives an indication (e.g., an update) from the operation 823, for informing the cache unit 830 that the channel-wise buffer-ID state has transitioned to the released state, and maintains the buffer ID state to be updated to “released” (for example, in the data property table 430 shown in FIG. 4B, in a situation where the cache unit 830 is taken as an example of the cache unit 112). Once in the released state, the cache quota associated with the channel-wise buffer-ID data becomes eligible for replacement. An outward arrow labeled “Replace buffer ID's data when other data's access traffic comes” from the operation 834 indicates that the cache unit 830 may replace the cache space corresponding to the released buffer-ID data when the access traffic from other data requests cache allocation. This replacement may involve I/O interactions between the cache unit 830 and any one of the GPU and the external memory (e.g., the GPU 420 and the memory 450 mentioned above), in particular, depending on discard or write-back behavior.

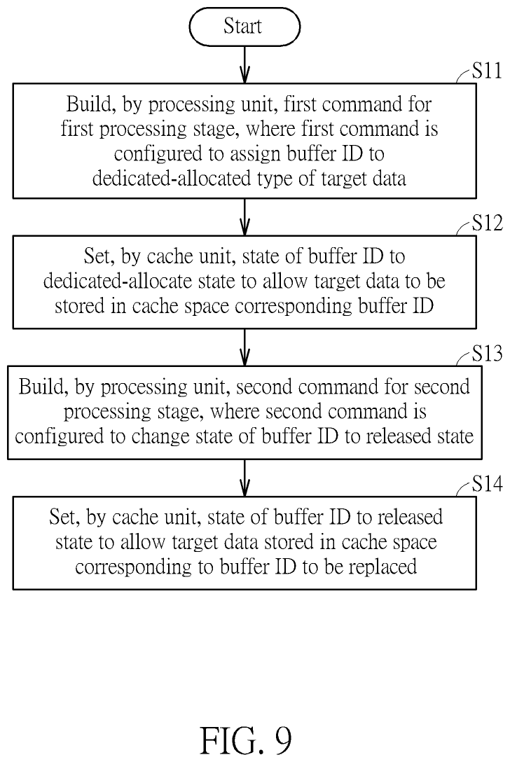

FIG. 9 illustrates a main working flow of the method according to an embodiment of the present disclosure. The aforementioned apparatus for dynamic cache control, such as the electronic device 100 shown in FIG. 1, can operate according to the working flow shown in FIG. 9.

In Step S11, the electronic device 100 can build, by the processing unit 111, the first command for the first processing stage, where the first command is configured to assign the buffer ID to the dedicated-allocated type of target data.

In Step S12, the electronic device 100 can set, by the cache unit 112, a state of the buffer ID to the dedicated-allocate state to allow the target data to be stored in the cache space corresponding to the buffer ID.

In Step S13, the electronic device 100 can build, by the processing unit 111, the second command for the second processing stage, where the second command is configured to change the state of the buffer ID to the released state.

In Step S14, the electronic device 100 can set, by the cache unit 112, the state of the buffer ID to the released state to allow the target data stored in the cache space corresponding to the buffer ID to be replaced.

For better comprehension, the method may be illustrated with the working flow shown in FIG. 9, but the present disclosure is not limited thereto. According to some embodiments, one or more steps may be added, deleted, or changed in the working flow shown in FIG. 9.

According to some embodiments, dynamic cache controlling can be utilized not only by a GPU but also by other processing units, and the cache quota may be shared across different processing units. This provides two advanced usage scenarios as described below:
(1) Dynamic cache controlling used independently by at least one other processing unit: another processing unit (e.g., an NPU) may develop or expose its own control API to interface with the dynamic cache-control mechanism, for example, in this scenario, data may be dedicated-allocated in the cache by the NPU, accessed by the NPU, and subsequently replaced by other data according to the cache unit's replacement policy, allowing non-GPU processing units to benefit from but not limited to: cache residency control for frequently accessed NPU data, bandwidth reduction during neural-network inference or training, and discard-after-use efficiency, when the NPU later transitions the buffer-ID state to released; and
(2) Cross-processing-unit data sharing through cache: dynamic cache controlling also enables cross-processing-unit data sharing directly through the cache, without requiring data exchange via the external DRAM, for example, data may first be dedicated-allocated in the cache by the GPU, and may then be accessed by the GPU and/or the NPU through the cache (since both the GPU and the NPU recognize the same buffer ID or channel-wise designation), and the cache quota may be finally released by the NPU, where in such a case, data transfer between the GPU and the NPU can occur directly through the cache without involving the DRAM, thereby reducing overall memory-bandwidth consumption and latency.

For brevity, similar descriptions for these embodiments are not repeated in detail here.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A method for dynamic cache control, comprising:
building, by a processing unit, a first command for a first processing stage, wherein the first command is configured to assign a buffer identifier (ID) to a dedicated-allocated type of target data;
setting, by a cache unit, a state of the buffer ID to a dedicated-allocate state to allow the target data to be stored in a cache space corresponding to the buffer ID;
building, by the processing unit, a second command for a second processing stage, wherein the second command is configured to change the state of the buffer ID to a released state; and
setting, by the cache unit, the state of the buffer ID to the released state to allow the target data stored in the cache space corresponding to the buffer ID to be replaced.

2. The method of claim 1, wherein when the state of the buffer ID is set to the dedicated-allocate state, the target data stored in the cache space corresponding to the buffer ID should not be replaced by subsequent data.

3. The method of claim 1, wherein the replaced target data is not written back to an external memory or a dynamic random access memory (DRAM).

4. The method of claim 1, wherein the processing unit is a graphics processing unit (GPU).

5. The method of claim 1, wherein the first and the second processing stages are different render passes, and the dedicated-allocated type of target data comprises a depth image.

6. The method of claim 5, wherein the second processing stage is a final render pass using the depth image.

7. The method of claim 1, wherein the dedicated-allocated type of target data comprises all data accessed by one or a combination of a tile buffer and a texture buffer.

8. The method of claim 1, wherein the dedicated-allocated type of target data is associated with a predefined access channel type.

9. The method of claim 1, wherein the processing unit is a neural processing unit (NPU), and the first and the second processing stages correspond to operations at different layers of a neural network.

10. The method of claim 1, wherein the state of the buffer ID is set to remain in the dedicated-allocate state across multiple processing stages until the cache unit receives a signal to change the state of the buffer ID to the released state.

11. The method of claim 1, wherein the dedicated-allocate state is non-exclusive, such that multiple buffer IDs remain in the dedicated-allocate state concurrently within the same processing stage, each occupying a respective cache quota.

12. An apparatus for dynamic cache control, the apparatus comprising:
at least one processing circuit, the processing circuit comprising:
a processing unit, configured to perform at least one processing operation; and
a cache unit, configured to perform at least one caching operation;
wherein:
the processing unit is configured to build a first command for a first processing stage, wherein the first command is configured to assign a buffer identifier (ID) to a dedicated-allocated type of target data;
the cache unit is configured to set a state of the buffer ID to a dedicated-allocate state to allow the target data to be stored in a cache space corresponding to the buffer ID;
the processing unit is configured to build a second command for a second processing stage, wherein the second command is configured to change the state of the buffer ID to a released state; and
the cache unit is configured to set the state of the buffer ID to the released state to allow the target data stored in the cache space corresponding to the buffer ID to be replaced.

13. The apparatus of claim 12, wherein when the state of the buffer ID is set to the dedicated-allocate state, the target data stored in the cache space corresponding to the buffer ID should not be replaced by subsequent data.

14. The apparatus of claim 12, wherein the replaced target data is not written back to an external memory or a dynamic random access memory (DRAM).

15. The apparatus of claim 12, wherein the processing unit is a graphics processing unit (GPU).

16. The apparatus of claim 12, wherein the first and the second processing stages are different render passes, and the dedicated-allocated type of target data comprises a depth image.

17. The apparatus of claim 12, wherein the dedicated-allocated type of target data comprises all data accessed by one or a combination of a tile buffer and a texture buffer.

18. The apparatus of claim 12, wherein the dedicated-allocated type of target data is associated with a predefined access channel type.

19. The apparatus of claim 12, wherein the processing unit is a neural processing unit (NPU), and the first and the second processing stages correspond to operations at different layers of a neural network.

20. The apparatus of claim 12, wherein the cache unit is located outside or inside the processing unit.
